(19) United States
(12) Patent Application Publication
(10) Pub. No.: US 2022/0089260 A1
(43) Pub. Date: Mar. 24, 2022

(54) OUTBOARD MOTOR

(71) Applicant: HONDA MOTOR CO., LTD., Tokyo (JP)

(72) Inventor: Tatsuya Kuroda, Wako-shi, Saitama (JP)

(21) Appl. No.: 17/428,751

(22) PCT Filed: Nov. 13, 2019
(86) PCT No.: PCT/JP2019/044572

§ 371 Date: Aug. 5, 2021

(30) Foreign Application Priority Data
Feb. 13, 2019 (JP) 2019-023594

(51) Int. Cl. B63H 20/00; B01D 53/94; B63H 21/21; F01N 3/20; F01N 3/24; F02D 41/04; F02D 41/14

(52) U.S. Cl. CPC B63H 20/001; B01D 53/94; B63H 21/21; F02D 41/14; F01N 3/24; F02D 41/04; F01N 3/20

(57) ABSTRACT

An outboard motor that controls combustion in an engine according to a purification rate by a catalyst and is capable of performing efficient engine combustion. The outboard motor includes a catalyst provided in an exhaust manifold of an engine and a second catalyst provided in an exhaust pipe, an air-fuel ratio sensor and an O2 sensor, which are located on an upstream side and a downstream side of the catalyst, respectively, and a controller for controlling combustion in the engine. The controller calculates an exhaust gas purification rate based on a value detected by the air-fuel ratio sensor or the O2 sensor and controls the combustion in the engine so as to make the exhaust gas purification rate appropriate.

### TECHNICAL FIELD

The present invention relates to an outboard motor.

### BACKGROUND ART

Conventionally, there has been proposed a structure for an outboard motor, which is coupled to an engine and in which catalysts for purifying exhaust gas discharged from the engine are mounted.

In general, because lean fuel combustion (combustion under an oxygen excessive atmosphere) in an engine causes large amounts of carbon monoxide (CO), hydrocarbons (HC), and nitrogen oxides (NOx) to be generated in exhaust gas, advanced catalyst technologies to cope with these CO, HC, and NOx have been demanded.

As a technology for oxidation-purifying CO and HC, there has been conventionally known a method for oxidizing CO and HC by using catalysts of noble metal such as platinum (Pt), palladium (Pd), and rhodium (Rh), and this method is applied to purify exhaust gas discharged from a diesel engine or the like. However, this method has a shortcoming in that this method cannot purify NOx.

As a technology for purifying NOx, a technology in which a urea aqueous solution or ammonia (NH3) is blown into an exhaust gas flow passage, and NOx and NH3 are chemically reacted with each other by utilizing a catalyst, thereby reduction-purifying NOx has been put into practical use. In addition, a technology in which prior to reduction-purifying NOx, nitrogen monoxide (NO) in exhaust gas is once oxidized to be nitrogen dioxide (NO2), thereby enhancing an efficiency of reduction-purifying NOx has also been known.

Here, when the exhaust gas is purified by using a catalyst, it is preferable that the oxidation or reduction reaction is performed at a predetermined air-fuel ratio.

Conventionally, as a technology for determining whether or not the exhaust gas is favorably purified, for example, there disclosed is a technology of a method which includes: a step of measuring a change over time in an oxidation rate of CO or HC which is oxidized by an exhaust gas oxidation catalyst and a change over time in an oxidation rate of NO which is oxidized by the exhaust gas oxidation catalyst; a step of, when it is determined based on each of the change over time in the oxidation rate of CO or HC and the change over time in the oxidation rate of NO that each of the oxidation rates of CO or HC and NO is decreased from an initial oxidation rate, determining that the exhaust gas oxidation catalyst has deteriorated due to sulfur (S) poisoning; a step of, when it is determined based on each of the change over time in the oxidation rate of CO or HC and the change over time in the oxidation rate of NO that each of the oxidation rates of CO or HC and NO is once increased from the initial oxidation rate and thereafter, is decreased from the initial oxidation rate, determining that the exhaust gas oxidation catalyst has deteriorated due to calcium (Ca) and/or barium (Ba) poisoning; and a step of supplying an air-fuel mixture which is rich in terms of a fuel ratio based on a stoichiometric air-fuel ratio and thereby recovering an oxidation capability of the exhaust gas oxidation catalyst (for example, Patent Document 1).

### CITATION LIST

### Patent Document

### [Patent Document 1]

Japanese Patent Application No. 2015-223583

### SUMMARY OF INVENTION

### Technical Problem

However, although in the technology disclosed in the above-mentioned Patent Document, a plurality of catalysts are installed in an exhaust pipe, and the exhaust gas is detected by sensors, a technology in which further, pieces of detection data are used and combustion in an engine is thereby controlled, and an efficiency of each of the catalysts is enhanced is not disclosed.

Therefore, an object of the present invention is to provide an outboard motor which controls combustion in an engine in accordance with purification rates achieved by catalysts and is operable to perform efficient combustion in the engine.

### Solution to Problem

In order to achieve the object, an aspect of the present invention includes: at least one catalyst which is provided in an exhaust flow passage of an engine; exhaust gas sensors which are installed on an upstream side and a downstream side of the catalyst; and a controller which performs combustion control in the engine, and the controller calculates a purification rate of exhaust gas based on a value detected by each of the exhaust gas sensors and performs combustion control in the engine so as to make the purification rate of the exhaust gas appropriate.

In the configuration, a second catalyst is installed on a downstream side of the exhaust gas sensor which is installed on the downstream side.

In the configuration, the controller performs combustion control in the engine by comparing an O2 amount of exhaust gas after passing through the catalyst, the O2 amount being detected by the exhaust gas sensor which is installed on the downstream side, with an appropriate O2 amount on a rich side and an appropriate O2 amount on a lean side, the appropriate O2 amounts being previously measured, and when the O2 amount of the exhaust gas after passing through the catalyst is out of a range of the appropriate O2 amount on the rich side and the appropriate O2 amount on the lean side, by correcting an air-fuel ratio such that the O2 amount is within the range of the appropriate O2 amount on the rich side and the appropriate O2 amount on the lean side.

In the configuration, when the O2 amount of the exhaust gas after passing through the catalyst is abnormal, the O2 amount being detected by the exhaust gas sensor which is installed on the downstream side, the controller determines that the catalyst is abnormal.

In the configuration, each of the exhaust gas sensors is any of an air-fuel ratio sensor or an O2 sensor.

In the configuration, the catalyst is a ceramic catalyst and the second catalyst is a metal catalyst.

In the configuration, a particulate filter is located on a downstream side of the second catalyst.

Note that in this description, Japanese Patent Application No. 2019-023594, filed on Feb. 13, 2019, is incorporated in its entirety.

### Advantageous Effects of Invention

According to an aspect of the present invention, based on a purification rate of a second catalyst, which is determined by a controller, a catalyst carried amount of the second catalyst can be appropriately determined, a noble metal amount used for the second catalyst can be made appropriate, and cost reduction owing to reduction in the noble metal amount can be devised. In addition, since purification rates made by a catalyst and the second catalyst can be appropriately determined, amounts of the catalyst and the second catalyst can be made minimum necessary amounts, thereby allowing the catalyst and the second catalyst to be downsized.

### BRIEF DESCRIPTION OF DRAWINGS

FIG. 1 is an essential part longitudinal sectional side view of an outboard motor according to the present embodiment.

FIG. 2 is a schematic block diagram illustrating an outline of an exhaust structure of an engine.

### DESCRIPTION OF EMBODIMENTS

Hereinafter, with reference to the accompanying drawings, an embodiment of the present invention will be described.

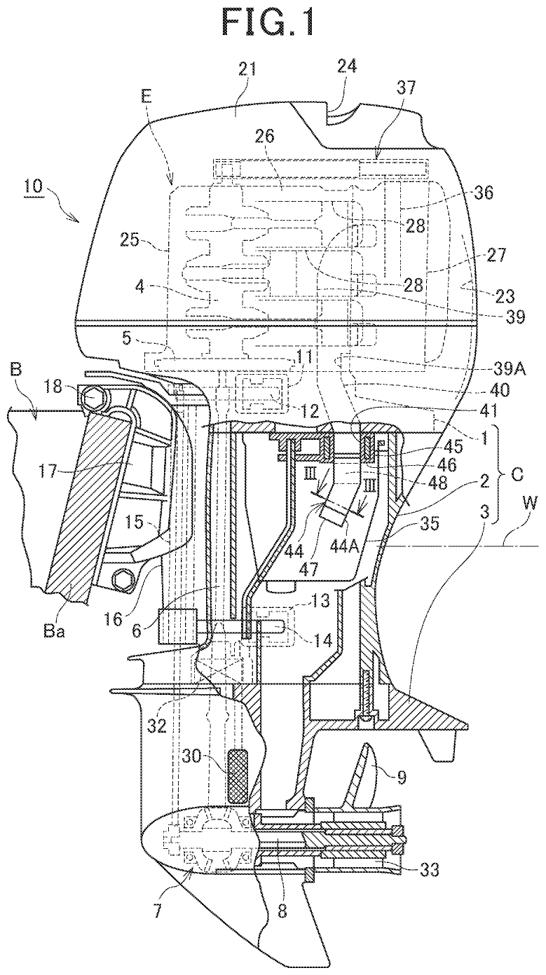

FIG. 1 is a longitudinal cross-sectional side view of a principal part of an outboard motor 10 according to the present embodiment. Note that in the below description, front, rear, right, and left are defined based on a state in which a boat B having the outboard motor 10 mounted thereon is planarly viewed.

As shown in FIG. 1, the outboard motor 10 has a casing C, and this casing C is constituted of a mount case 1, an extension case 2 which is connected to a lower end surface of the mount case 1, and a gear case 3 which is connected to a lower end surface of the extension case 2. On an upper end surface of the mount case 1, a multicylinder engine E is mounted with a crank shaft 4 longitudinally mounted.

The outboard motor 10 is provided with a pair of right and left upper arms 12 which support the mount case 1 via an upper mount rubber 11 and a pair of right and left lower arm 14 which support the extension case 2 via a lower mount rubber 13. Between these upper arms 12 and the lower arm 14, a swivel shaft 15 is connected. In addition, a swivel case 16 which rotatably supports the swivel shaft 15 is upwardly and downwardly swingably supported via a tilt shaft 18 in a horizontal direction with respect to a stern bracket 17 which is attached to a transom Ba of the boat B.

An under cover (not shown) which is formed of synthetic resin and is ring-shaped is fixedly attached to the mount case 1. This under cover covers the periphery of a section from a lower portion of the engine E to an upper portion of the extension case 2, and on an upper end of the under cover, an engine hood 21 which covers the engine E from above is detachably attached. An engine room 23 which houses the engine E is defined by the engine hood 21 and the under cover. In an upper portion of the engine hood 21, an air intake port 24 from which air is taken into the engine room 23 is provided.

Connected to a lower end of the crank shaft 4 is a driving shaft 6 together with a flywheel 5. The driving shaft 6 extends downward in an inside of the extension case 2, a lower end of the driving shaft 6 is connected to a propeller shaft 8 in a horizontal direction via a forward/backward travelling switching mechanism 7 which is provided in an inside of the gear case 3, and on a rear end of the propeller shaft 8, a propeller 9 is fixedly attached.

The engine E has a crank case 25 which supports the longitudinally mounted crank shaft 4, a cylinder block 26 which extends backward from the crank case 25, and a cylinder head 27 which is joined to a rear end of the cylinder block 26. A lower surface of the crank case 25 is bolt-connected to the mount case 1. The cylinder block 26 includes a plurality of cylinders 28.

In a lower portion of the gear case 3, a water intake port 30 which opens in a one side surface thereof and through which outside water is taken in is provided. The outside water taken in from the water intake port 30 is pneumatically fed by a water pump 32 to the engine E as cooling water and cools respective parts of the engine E. The cooling water which has finished cooling of the engine E is released into the extension case 2 and is discharged outside through a discharge hole 33 which is formed in a boss of the propeller shaft 8.

Connected to a lower surface of the mount case 1 is an oil pan 35 which is located in the central portion of an upper portion inside the extension case 2, and lubricating oil which is supplied to the parts of the engine E is stored in the oil pan 35.

Right and left camshafts 36 for a valve system, which are in parallel with the crank shaft 4, are rotatably supported to the cylinder head 27. A belt-type timing transmission device 37 which drives these camshafts 36 at a predetermined speed reduction ratio from the crank shaft 4 is disposed above the cylinder block 26.

The cylinder head 27 is provided with an exhaust manifold 39 which communicates with a plurality of exhaust ports. An exhaust outlet 39A which opens in a lower end of the exhaust manifold 39 communicates with a tubular exhaust passage 40 which extends on a lower surface of the mount case 1. On the lower surface of the mount case 1, the exhaust passage 40 is joined to an exhaust guide 41 which is connected to the oil pan 35 inside the extension case 2. A connecting flange 45 which is formed at an upper end of the exhaust pipe 44 is flange-connected to a lower end portion of the exhaust guide 41. The exhaust pipe 44 extends downward in the inside of the extension case 2, has an exhaust port 47 of a lower end part 44A, with the exhaust port 47 opening in the casing C, and discharges the exhaust gas of the engine E inside the casing C. Below a height at which the exhaust port 47 of the lower end part 44A is located, a draft line W upon normal navigation of the boat B is located.

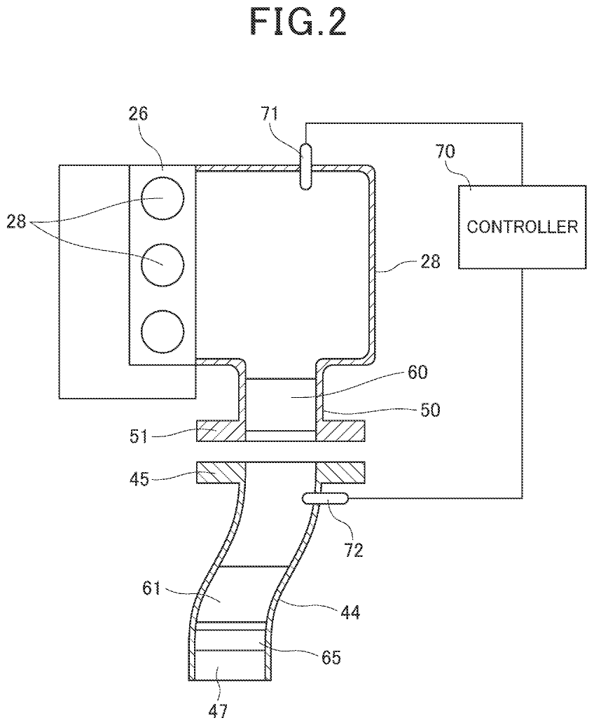

FIG. 2 is a schematic configuration diagram schematically illustrating an exhaust structure of the engine.

As shown in FIG. 2, the engine E is a multicylinder gasoline engine E, and in the engine E, the exhaust manifold 39 which is box-shaped is connected to the cylinder head 27 of the engine E.

Below the exhaust manifold 39, the exhaust pipe 44 is connected. In a lower end of the exhaust manifold 39, a connecting part 50 which extends downward is provided, and in a lower end portion of the connecting part 50, a flange 51 is provided.

A connecting flange 45 of the exhaust pipe 44 is connected to the flange 51 of the connecting part 50, and thus, the exhaust pipe 44 is configured to be connected to the lower end portion of the exhaust manifold 39. Theses exhaust manifold 39 and exhaust pipe 44 constitute an exhaust flow passage.

In the present embodiment, inside the connecting part 50 of the exhaust manifold 39, a catalyst 60 is disposed.

In addition, in the present embodiment, inside the exhaust pipe 44, a second catalyst 61 is disposed.

Each of the catalyst 60 and the second catalyst 61 is a three-way catalyst which oxidizes harmful components such as hydrocarbons (HC), carbon monoxide (CO), and nitrogen oxides (NOx) in exhaust gas and removes the harmful components by reduction reaction and has a honeycomb catalyst structure obtained, for example, by coating a porous honeycomb structure with a catalyst component such as platinum, palladium, and rhodium. Note that the structure of each of the catalyst 60 and the second catalyst 61 is not limited to the honeycomb catalyst structure and may be a simplified structure such as a plate catalyst structure with the catalyst component carried on a plate member.

For example, as the catalyst 60, a ceramic catalyst is used to enhance a purification rate, and as the second catalyst 61 provided in the exhaust pipe 44, a metal catalyst is used to reduce an exhaust pressure loss and costs. Thus, comprehensive balance of the exhaust pressure loss and the costs can be taken.

Note that as long as the comprehensive balance of the exhaust pressure loss and the costs can be taken, as the catalyst 60, the metal catalyst may be used, and as the second catalyst 61, the ceramic catalyst may be used.

In addition, the outboard motor 10 includes a controller 70. The controller 70 is constituted of a microcomputer or the like and centrally controls parts of the outboard motor 10, which include an engine E23.

The controller 70 performs normal control for the engine E, which controls a fuel injection amount in accordance with a throttle amount, a rotation speed of the engine E, and the like, and has a function to perform lean combustion control in which an air-fuel ratio as a mixture ratio of fuel and air is controlled to a lean side or the like by appropriately adjusting the fuel injection amount and the like upon controlling this engine E.

In the present embodiment, above the exhaust manifold 39, an air-fuel ratio sensor 71 as an exhaust gas sensor for detecting the air-fuel ratio of the exhaust gas inside the exhaust manifold 39 is provided. The air-fuel ratio sensor 71 is to detect the air-fuel ratio of the exhaust gas exhausted from a cylinder head 27. Note that although an example in which as the exhaust gas sensor, the air-fuel ratio sensor 71 is used is described, the present invention is not limited to this, and an O2 sensor which detects an O2 amount or an NOx sensor which detects concentration of NOx may be used.

Between the catalyst 60 installed in a connecting part 50 of the exhaust manifold 39 and the second catalyst installed in the exhaust pipe 44, an O2 sensor 72 as an exhaust gas sensor is provided. The O2 sensor 72 is to detect an O2 amount contained in the exhaust gas.

Based on detection results of the air-fuel ratio sensor 71 and the O2 sensor 72, the controller 70 acquires information which can identify exhaust purification states of the catalyst 60 and the second catalyst 61.

More specifically, based on the air-fuel ratio detected by the air-fuel ratio sensor 71 and the O2 amount detected by the O2 sensor 72, the controller 70 obtains a purification rate after passing through the catalyst 60 by employing the heretofore known technique.

Based on the purification rate of the exhaust gas after passing through the catalyst 60, the controllers 70 determines what amount of purification attained by the second catalyst 61 makes exhaust gas after passing through the second catalyst 61 appropriate.

Thus, based on the purification rate of the second catalyst 61 determined by the controller 70, a catalyst carried amount of the second catalyst 61 can be appropriately determined, a noble metal amount used for the second catalyst 61 can be made appropriate, and cost reduction owing to reduction in the noble metal amount can be devised.

In addition, since the purification rates made by the catalyst 60 and the second catalyst 61 can be appropriately determined, amounts of the catalyst 60 and the second catalyst 61 can be made minimum necessary amounts, thereby allowing the catalyst 60 and the second catalyst 61 to be downsized.

In addition, the controller 70 compares the O2 amount of the exhaust gas after passing through the catalyst 60, which is detected by the O2 sensor 72, with an appropriate O2 amount thereof on a rich side and an appropriate O2 amount on a lean side, which are previously measured, and determines whether or not the O2 amount thereof after passing through the catalyst 60 is within an appropriate range.

Then, the controller 70 is configured to perform combustion control in the engine E such that when the detected O2 amount after passing through the catalyst 60 is out of a range of the appropriate O2 amount on the rich side and the appropriate O2 amount on the lean side, the controller 70 corrects an air-fuel ratio so as to allow the O2 amount after passing through the catalyst 60 to be within the above-mentioned range of the appropriate O2 amount on the rich side and the appropriate O2 amount on the lean side.

As described above, the purification rate of the exhaust gas is compared with the appropriate O2 amounts, thereby allowing the air-fuel ratio of the engine E to be accurately retained.

In addition, the controller 70 is configured to determine, when the O2 amount of the exhaust gas is detected and this O2 amount is abnormal, that the catalyst 60 is abnormal, for example, due to aging deterioration (breakdown, degradation, and the like).

Then, for example, means for notifying an operator of a ship when the controller 70 determines that the catalyst 60 is abnormal may be provided. Thus, violation of exhaust gas regulation of the exhaust gas due to abnormality of the catalyst 60 can be prevented, and it is also made possible to protect the engine E.

In addition, on a downstream side of the second catalyst 61 in the exhaust pipe 44, that is, in the vicinity of an exhaust port 47, a particulate filter 65 is located. Particulates contained in the exhaust gas, which has passed through the catalyst 60 and the second catalyst 61, can be removed by the particulate filter 65. Thus, it is made possible to cope with PM regulation and PN regulation.

Next, operation of the present embodiment will be described.

In the present embodiment, by driving the engine E, a driving force of the engine E is transmitted to a propeller shaft 8 via a crank shaft 4, and a driving shaft 6, and this rotates a propeller 9, thereby advancing and backing a boat.

The exhaust gas exhausted from the cylinder head of the engine E is sent from the exhaust manifold 39 to the exhaust pipe 44.

Then, the harmful components in the exhaust gas are removed by oxidation and reduction reaction made by the catalyst 60 and the second catalyst 61, and the exhaust gas is exhausted to an extension case 2 via the exhaust port 47 of the exhaust pipe 44 and thereafter, is exhausted into water from a portion of the propeller 9.

In addition, in the present embodiment, based on the air-fuel ratio detected by the air-fuel ratio sensor 71 and the O2 amount detected by the O2 sensor 72, the controller 70 obtains the purification rate of the exhaust gas after passing through the catalyst 60 and based on the purification rate of the exhaust gas after passing through the catalyst 60, the controllers 70 determines what amount of purification attained by the second catalyst 61 makes exhaust gas after passing through the second catalyst 61 appropriate.

Thus, based on the purification rate of the second catalyst 61 determined by the controller 70, a catalyst carried amount of the second catalyst 61 can be appropriately determined, a noble metal amount used for the second catalyst 61 can be made appropriate, and cost reduction owing to reduction in the noble metal amount can be devised.

In addition, since the purification rates made by the catalyst 60 and the second catalyst 61 can be appropriately determined, amounts of the catalyst 60 and the second catalyst 61 can be made minimum necessary amounts, thereby allowing the catalyst 60 and the second catalyst 61 to be downsized.

In addition, the controller 70 compares the O2 amount of the exhaust gas after passing through the catalyst 60, which is detected by the O2 sensor 72, with the appropriate O2 amount thereof on the rich side and the appropriate O2 amount on the lean side, which are previously measured, and determines whether or not the O2 amount thereof after passing through the catalyst 60 is within the appropriate range.

Then, the controller 70 performs the combustion control in the engine E such that when the detected O2 amount after passing through the catalyst 60 is out of the range of the appropriate O2 amount on the rich side and the appropriate O2 amount on the lean side, the controller 70 corrects the air-fuel ratio so as to allow the O2 amount after passing through the catalyst 60 to be within the above-mentioned range of the appropriate O2 amount on the rich side and the appropriate O2 amount on the lean side.

As described above, the purification rate of the exhaust gas is compared with the appropriate O2 amounts, thereby allowing the air-fuel ratio of the engine E to be accurately retained.

In addition, when the O2 amount of the exhaust gas is detected and this O2 amount is abnormal, the controller 70 determines that the catalyst 60 is abnormal, for example, due to aging deterioration.

Thus, the violation of exhaust gas regulation of the exhaust gas due to the abnormality of the catalyst 60 can be prevented, and it is also made possible to protect the engine E.

As described hereinbefore, in the present embodiment, the catalyst 60 provided in the exhaust manifold 39 of the engine E and the second catalyst 61 provided in the exhaust pipe 44, the air-fuel ratio sensor 71 and the O2 sensor 72 provided on the upstream side and downstream side of the catalyst 60, respectively, and the controller 70 which performs the combustion control in the engine E are included, and based on a value detected by the air-fuel ratio sensor 71 or the O2 sensor 72, the controller 70 calculates the purification rate of the exhaust gas and performs the combustion control in the engine E so as to make this purification rate of the exhaust gas appropriate.

Thus, based on the purification rate of the second catalyst 61 determined by the controller 70, the catalyst carried amount of the second catalyst 61 can be appropriately determined, the noble metal amount used for the second catalyst 61 can be made appropriate, and the cost reduction owing to the reduction in the noble metal amount can be devised. In addition, since the purification rates made by the catalyst 60 and the second catalyst 61 can be appropriately determined, the amounts of the catalyst 60 and the second catalyst 61 can be made the minimum necessary amounts, thereby allowing the catalyst 60 and the second catalyst 61 to be downsized.

In addition, in the present embodiment, the controller 70 performs the combustion control in the engine E by comparing the O2 amount of the exhaust gas after passing through the catalyst 60, which is detected by the O2 sensor 72, with the appropriate O2 amount thereof on the rich side and the appropriate O2 amount on the lean side, which are previously measured, and when the O2 amount of the exhaust gas after passing through the catalyst 60 is out of the range of the appropriate O2 amount on the rich side and the appropriate O2 amount on the lean side, the controller 70 corrects the air-fuel ratio so as to allow the O2 amount to be within the range of the appropriate O2 amount on the rich side and the appropriate O2 amount on the lean side.

Thus, by comparing the O2 amount of the exhaust gas with the appropriate O2 amounts, the air-fuel ratio of the engine E can be accurately retained.

In addition, in the present embodiment, when the O2 amount of the exhaust gas after passing through the catalyst 60, which is detected by the O2 sensor 72, is abnormal, the controller 70 determines that the catalyst 60 is abnormal.

Thus, the violation of exhaust gas regulation of the exhaust gas due to the abnormality of the catalyst 60 can be prevented, and it is also made possible to protect the engine E.

In addition, in the present embodiment, the particulate filter 65 is located on the downstream side of the second catalyst 61.

Thus, the particulates contained in the exhaust gas, which has passed through the catalyst 60 and the second catalyst 61, can be removed by the particulate filter 65. Thus, it is made possible to cope with the PM regulation and the PN regulation.

The above-described embodiment is merely one embodiment of the present invention, and any modifications and applications can be made without departing from the spirit of the present invention.

For example, although in the above-described embodiment, the case where the engine E is a gasoline engine is described, the engine E may be an engine, such as a diesel engine, for which the purification of the exhaust gas is required. As each of the catalyst 60 and the second catalyst 61, it is only required to select appropriate catalyst 60 and second catalyst 61 in accordance with the engine E, and for example, in a case of the diesel engine, it is only required to use a catalyst, such as a selection catalyst reduction (SCR) catalyst or a soot catalyst (SC), which is suited for the diesel engine.

### REFERENCE SIGNS LIST

10 Outboard Motor
27 Cylinder Head
39 exhaust manifold
44 exhaust pipe
45 connecting flange
47 exhaust port
50 connecting part
51 flange
60 catalyst
61 second catalyst
65 Particulate filter
70 controller
71 Air-fuel ratio sensor
72 O2 sensor
B Boat
C Casing
E Engine

1. An outboard motor comprising:
a first catalyst, which is installed in an exhaust flow passage of an engine;
a second catalyst, which is installed on a downstream side of the first catalyst;
exhaust gas sensors, which are installed on an upstream side and a downstream side of the first catalyst; and
a controller, which performs combustion control in the engine, wherein
based on a value being detected by the exhaust gas sensor, which is installed on the downstream side, the controller calculates a purification rate of exhaust gas after passing through the first catalyst and based on the purification rate of the exhaust gas after passing through the first catalyst, determines what amount of purification attained by the second catalyst makes exhaust gas after passing through the second catalyst appropriate, and
the controller calculates the purification rate of exhaust gas based on the value being detected by the exhaust gas sensor, which is installed on the downstream side and performs the combustion control in the engine so as to make the purification rate of the exhaust gas appropriate.

2. The outboard motor according to claim 1, wherein the controller performs combustion control in the engine by comparing an O2 amount of exhaust gas after passing through the first catalyst, the O2 amount being detected by the exhaust gas sensor which is installed on the downstream side, with an appropriate O2 amount on a rich side and an appropriate O2 amount on a lean side, the appropriate O2 amounts being previously measured, and when the O2 amount of the exhaust gas after passing through the first catalyst is out of a range of the appropriate O2 amount on the rich side and the appropriate O2 amount on the lean side, by correcting an air-fuel ratio such that the O2 amount is within the range of the appropriate O2 amount on the rich side and the appropriate O2 amount on the lean side.

3. The outboard motor according to claim 1, wherein when the O2 amount of the exhaust gas after passing through the first catalyst is abnormal, the O2 amount being detected by the exhaust gas sensor which is installed on the downstream side, the controller determines that the first catalyst is abnormal.

4. The outboard motor according to claim 1, wherein each of the exhaust gas sensors is any of an air-fuel ratio sensor or an O2 sensor.

5. The outboard motor according to claim 1, wherein the first catalyst is a ceramic catalyst and the second catalyst is a metal catalyst.

6. The outboard motor according to claim 1, wherein a particulate filter is located on a downstream side of the second catalyst.

7. (canceled)
